(19) United States
(12) Patent Application Publication
(10) Pub. No.: US 2026/0085698 A1
(43) Pub. Date: Mar. 26, 2026

(54) ARTICULATING PUMP FOR SUBMERGING INTO A FLUID RESERVOIR

(71) Applicant: ibex Innovation Inc., Tavistock (CA)

(72) Inventors: Dale Horst, Tavistock (CA); Clifford Horst, Tavistock (CA); Abraham Harder, Tavistock (CA)

(21) Appl. No.: 19/340,064

(22) Filed: Sep. 25, 2025

Related U.S. Application Data
(60) Provisional application No. 63/699,074, filed on Sep. 25, 2024.

(51) Int. Cl. F04D 29/40; F04D 13/02; F15B 15/00

(52) U.S. Cl. CPC F04D 29/406; F04D 13/02; F15B 15/00

(57) ABSTRACT

Articulating pumps and pump heads of articulating pumps are described here. The articulating pumps include a frame for coupling the pump to an implement and a pump body rotatably coupled to the frame. The pump body has a first body portion and a second body portion. The pump body also includes an elongated fluid conduit that extends downwardly relative to the frame. A pump head is coupled to an inlet of the elongated fluid conduit. The pump head has a fluid inlet on an underside and a fluid outlet on an upper side thereof. The elongated fluid conduit receives fluid from the pump head. A drive shaft enters the pump head through the fluid outlet of the pump head and into a cavity of the pump head. An impeller is coupled to the drive shaft and directs fluid into the pump head and the elongated fluid conduit.

### RELATED APPLICATIONS

The present application claims priority to United States Provisional Patent Application 63/699,074 entitled Articulating Pump For Submerging Into A Fluid Reservoir filed on Sep. 25, 2024, the entire contents of which are incorporated by reference herein.

### TECHNICAL FIELD

The embodiments disclosed herein relate to pumps and more particularly to articulating pumps to submerge into a fluid reservoir.

### BACKGROUND

Large manure reservoirs above or below the ground, oftentimes within a barn, are used to store liquid manure from animals until it is spread onto farmland for disposal. To remove the manure from the reservoir, a pump is submerged into the reservoir from above. Typically the pump is either free standing or attached to a farm implement, such as but not limited to a tractor, or other power supply unit Current pumps used in large manure reservoirs are often difficult to manipulate to various depths and areas within the reservoir. For instance, it is desirable to be able to move the pump within the large reservoir to different areas to efficiently remove all of the liquid manure. Specifically, manure reservoirs are typically square or rectangular shaped and it can be difficult to maneuver the pump into some portions of the tank, such as the corners of the tank. Further, large manure reservoirs often have variable depths and/or sloped sidewalls and many current pumps are unable to accommodate for these variances.

There is a need for a new and improved pumps and more particularly a pump that articulates to accommodate different depths for submerging into a fluid reservoir, such as but not limited to a large manure reservoir, that address at least some of the difficulties noted above.

### SUMMARY

In accordance with a broad aspect, an articulating pump for submerging in a fluid reservoir is described herein. The articulating pump has a frame for coupling the pump to an implement and a pump body rotatably coupled to the frame. The pump body has a first body portion rotatably coupled to the frame; and a second body portion rotatably coupled to the first body portion. The pump also has an elongated fluid conduit coupled to the second body portion and extending downwardly relative to the frame and a pump head coupled to an inlet of the elongated fluid conduit at a position spaced apart from the second body portion. The pump head has a fluid inlet on an underside and a fluid outlet on an upper side thereof. The elongated fluid conduit is fluidly coupled to the outlet to receive fluid from the pump head. The pump also has a drive shaft coupled to the second body portion of the pump body and extending downwardly relative to the frame. The drive shaft enters the pump head through the fluid outlet of the pump head and into a cavity of the pump head. The pump also has an impeller coupled to the drive shaft. The impeller extends downwardly from the pump head to direct fluid from the fluid reservoir into the inlet of the pump head and, subsequently, the inlet of the elongated fluid conduit.

In at least one embodiment, the pump also includes at least one actuator coupled to the first body portion and the second body portion, the at least one actuator configured to rotate the second body portion about the first body portion.

In at least one embodiment, the at least one actuator coupled to the first body portion and the second body portion includes a first pair of hydraulic actuators.

In at least one embodiment, the pump also includes at least one actuator coupled to the frame and to the first body, the at least one actuator configured to rotate the first body portion about the frame.

In at least one embodiment, the at least one actuator coupled to the first body portion and the frame includes a second pair of hydraulic actuators.

In at least one embodiment, the pump also includes at least one actuator coupled to the first body portion and the second body portion.

In at least one embodiment, the at least one actuator coupled to the first body portion and the second body portion includes a third pair of hydraulic actuators.

In at least one embodiment, the drive shaft is transverse with the elongated fluid conduit.

In at least one embodiment, the drive shaft is powered by a power source.

In accordance with another broad aspect, an articulating pump for submerging in a fluid reservoir is described herein. The articulating pump includes a frame for coupling the pump to an implement; a pump body rotatably coupled to the frame, the pump body having: a first body portion rotatably coupled to the frame; and a second body portion rotatably coupled to the first body portion; a drive shaft coupled to the second body portion of the pump body and extending downwardly relative to the frame; a drive means coupled to a power take-off of the implement and configured to transfer power of the implement to the drive shaft; an elongated fluid conduit coupled to the second body portion and extending downwardly relative to the frame; a pump head coupled to an inlet of the elongated fluid conduit at a positioned spaced apart from the second body portion, the pump head having a fluid inlet on an underside and a fluid outlet on an upper side thereof, the elongated fluid conduit being fluidly coupled to the outlet to receive fluid from the pump head; and an impeller coupled to the drive shaft, the impeller extending downwardly from the pump head to direct fluid from the fluid reservoir into the inlet of the pump head and, subsequently, the inlet of the elongated fluid conduit.

In at least one embodiment, the drive means includes a first gear box, a second gear box, and a transfer mechanism to transfer power from the first gear box to the second gear box.

In at least one embodiment, the transfer mechanism is a belt.

In at least one embodiment, the transfer mechanism is a rotating shaft between two additional gear boxes In at least one embodiment, the first gear box is coupled to the first body portion.

In at least one embodiment, the second gear box is coupled to the second body portion.

In at least one embodiment, the pump is also configured for the power to be transferred to the pump head while the first body portion and the second body portion are in any position.

In accordance with another broad aspect, a pump head of an articulating pump is described herein. The pump head includes an outer conical outer housing having: a fluid inlet on an underside of the outer housing; a fluid outlet on an upper side of the outer housing, the fluid outlet being configured to be fluidly coupled to an inlet of an elongated conduit to direct fluid into the elongated fluid conduit; and an inner cavity fluidly coupled to the fluid inlet; an inner conical housing positioned within the outer conical housing, the inner housing defining a first inner cavity for receiving a drive shaft of the articulating pump, the drive shaft being coupled to an impeller extending outwardly from the fluid inlet on the underside of the inner cone; and one or more vanes fluidly coupled to the inner cavity and configured to receive the fluid from the inner cavity and direct the fluid towards the fluid outlet, the vanes passing between the outer housing and the inner housing and around the inner housing.

In at least one embodiment, the outer housing has a frustoconical shape.

In at least one embodiment, the vanes are configured to carry the fluid in a first direction upwardly relative to the underside of the housing and a second direction curved around at least a portion of the inner housing.

In at least one embodiment, the pump includes a pair of agitation nozzles, each agitation nozzle being configured to operate independently of the other agitational nozzle.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a perspective view from above of an articulating pump, according to at least one embodiment described herein.

FIG. 1B is a partial cross-sectional view of the articulating pump of FIG. 1A.

FIG. 1C is a magnified view of the portion of the articulating pump of FIG. 1B indicated with ‘B’.

FIG. 1D is a front view of the articulating pump of FIG. 1A.

FIG. 1E is a top view of the articulating pump of FIG. 1A.

FIG. 1F is a side view of the articulating pump of FIG. 1A.

FIG. 1G is a side view of the articulating pump of FIG. 1A at a fully retracted position.

FIG. 1H is a side view of the articulating pump of FIG. 1A at a fully extended position.

FIG. 2A is a perspective view of another embodiment of an articulating pump according to at least one embodiment described herein.

FIG. 2B is a top view of the articulating pump of FIG. 2A.

FIG. 2C is a side view of the articulating pump of FIG. 2A.

FIG. 3A is a perspective view of another embodiment of an articulating pump according to at least one embodiment described herein.

FIG. 3B is a top view of the articulating pump of FIG. 2A.

FIG. 3C is a side view of the articulating pump of FIG. 2A.

FIG. 4A is a side view of a pump head of an articulating pump, according to at least one embodiment described herein.

FIG. 4B is a cross-sectional view of the pump head of FIG. 3A.

FIG. 4C is another cross-sectional view looking down into the pump head of FIG. 3A.

FIG. 4D is a perspective view from above of the pump head of FIG. 3A.

### DETAILED DESCRIPTION

Various systems, apparatus, compositions and processes will be described below to provide an example of one or more embodiments. No embodiment described below limits any claimed embodiment and any claimed embodiment may cover systems, apparatus, compositions or processes that differ from those described below. The claimed embodiments are not limited to systems, apparatus, compositions or processes having all of the features of any one system, apparatus, composition or process described below or to features common to multiple or all of the systems, apparatus, compositions or processes described below. It is possible that a system, apparatus, composition or process described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

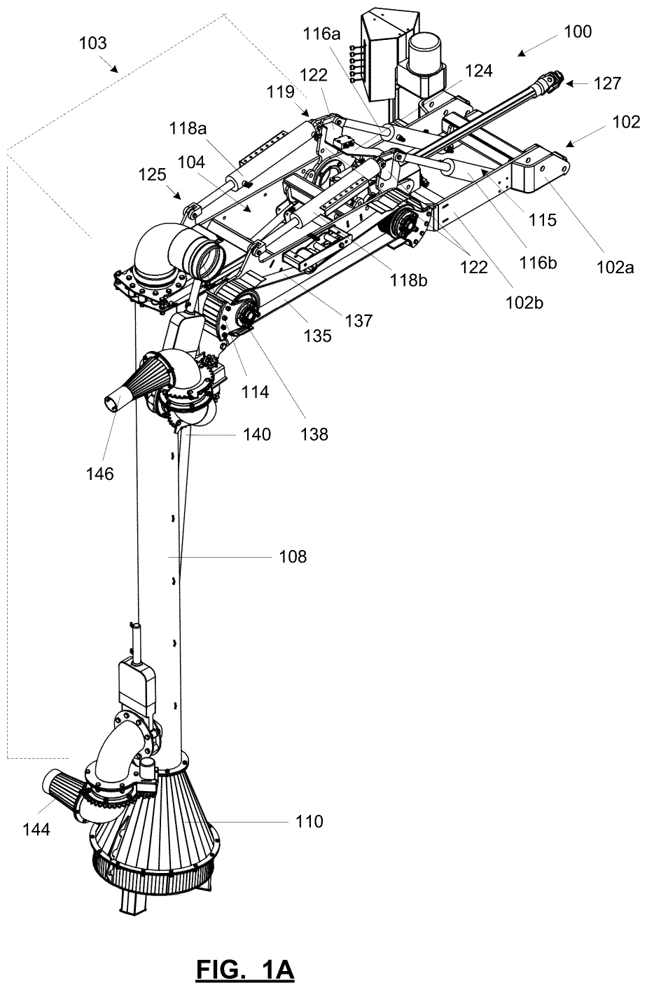

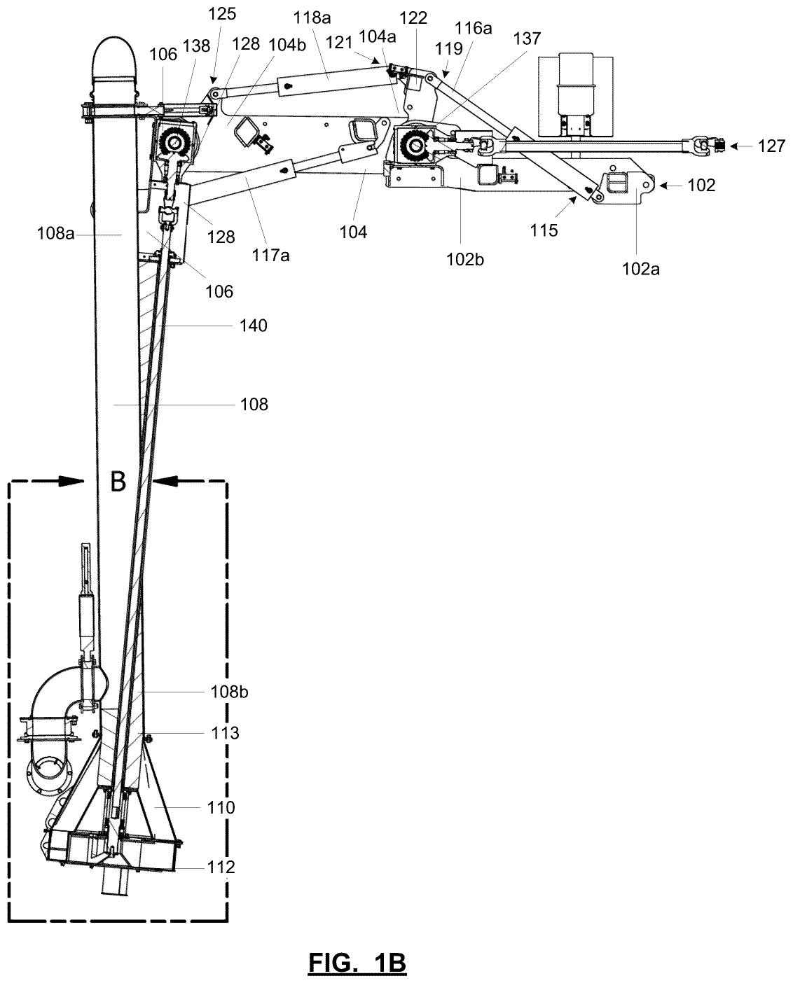

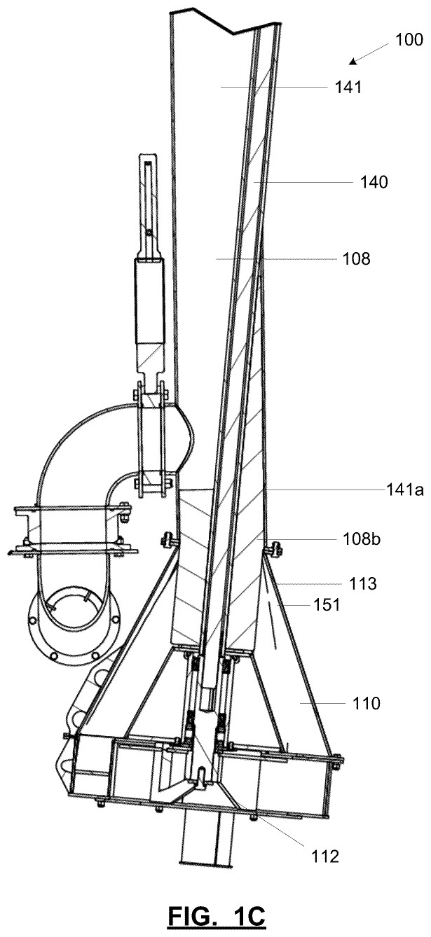

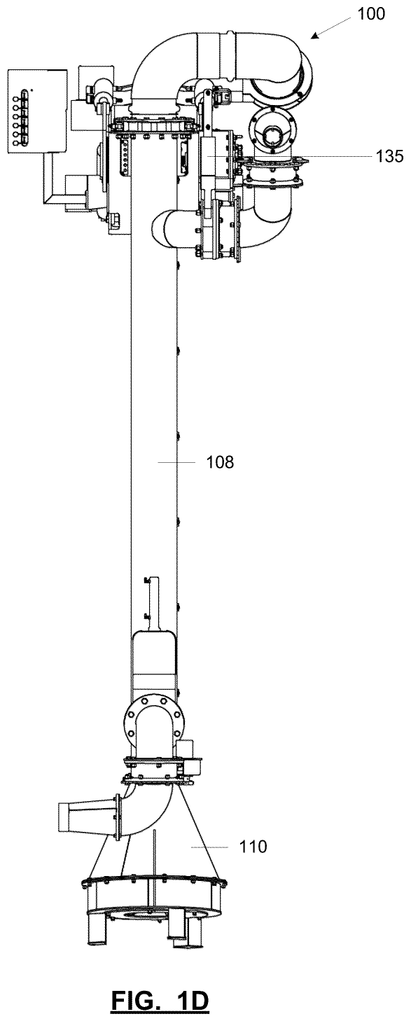

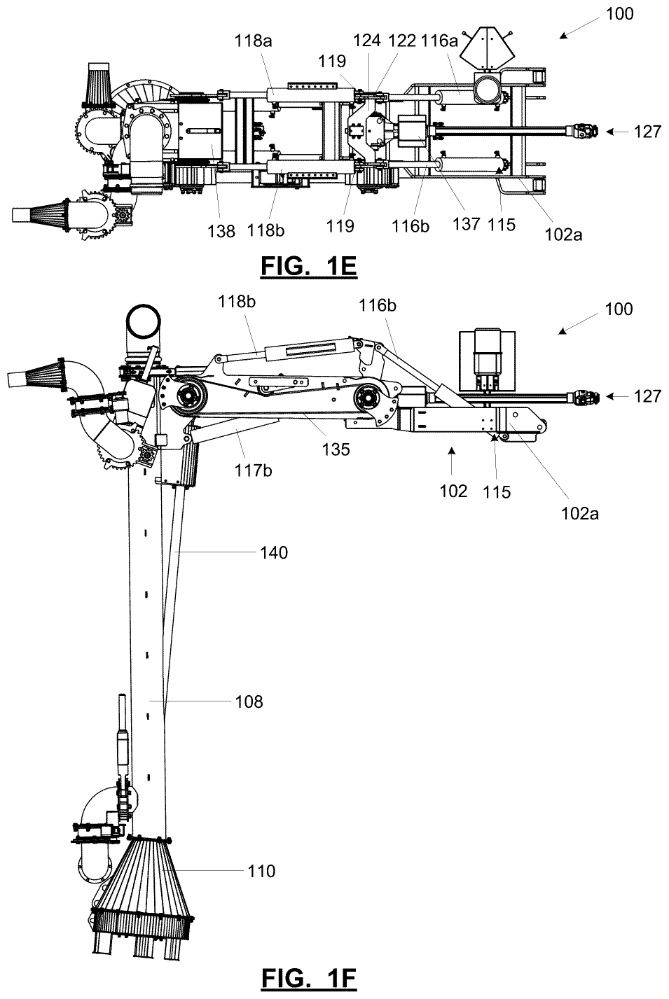

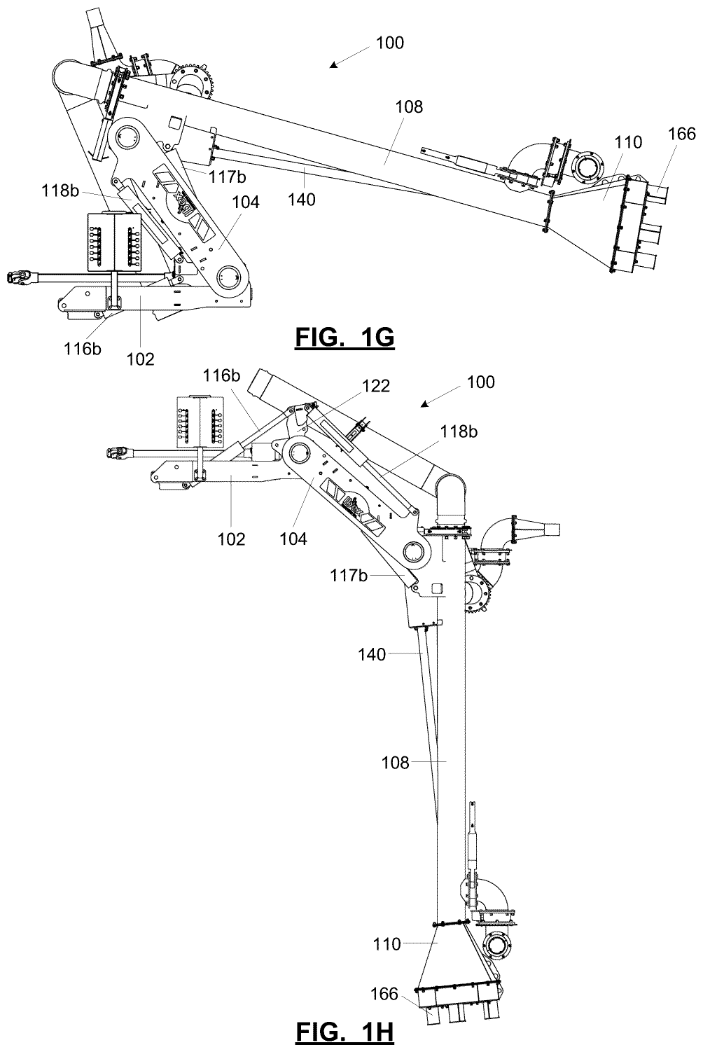

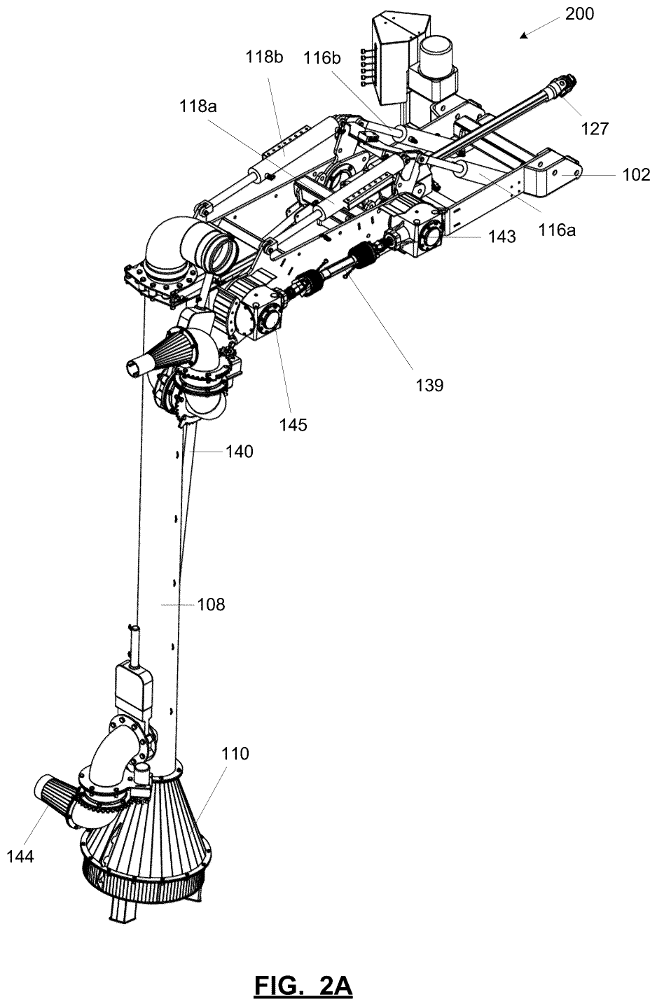

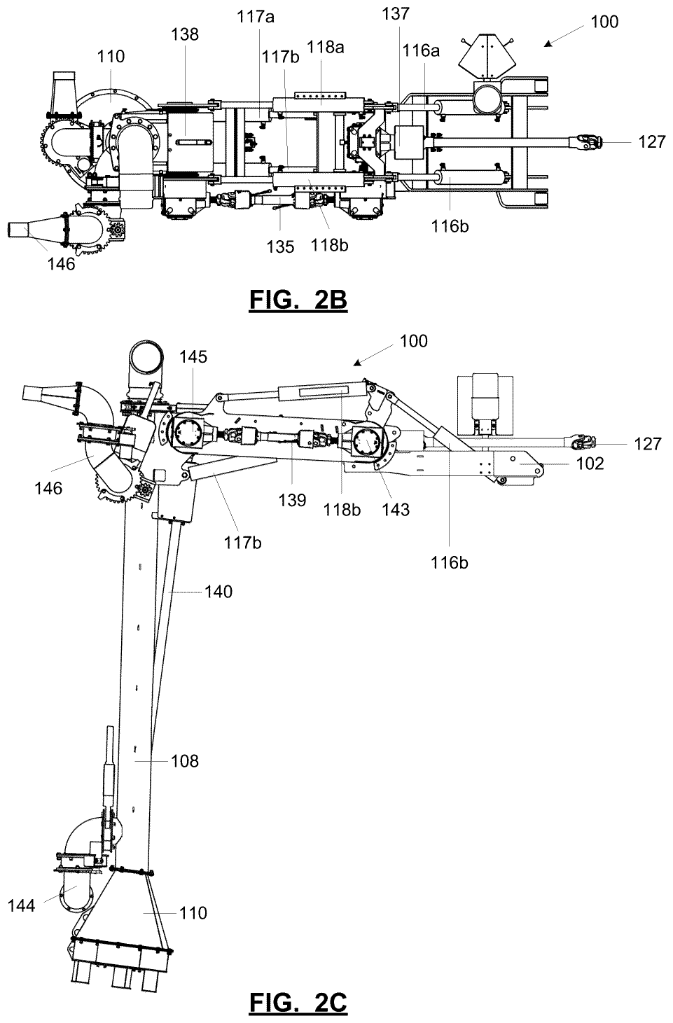

Turning now to the figures, FIG. 1A-1H show views of an articulating pump 100 according to at least one embodiment described here. FIGS. 2A-2C show an articulating pump 200 according to at least one other embodiment described herein. The articulating pumps 100 and 200 described below differ in the mechanisms used to transfer power between gearbox 137 and gearbox 138 (as described in greater detail below). Pump 100 and pump 200 use a same mechanism to move their respective pump heads relative to their respective frames.

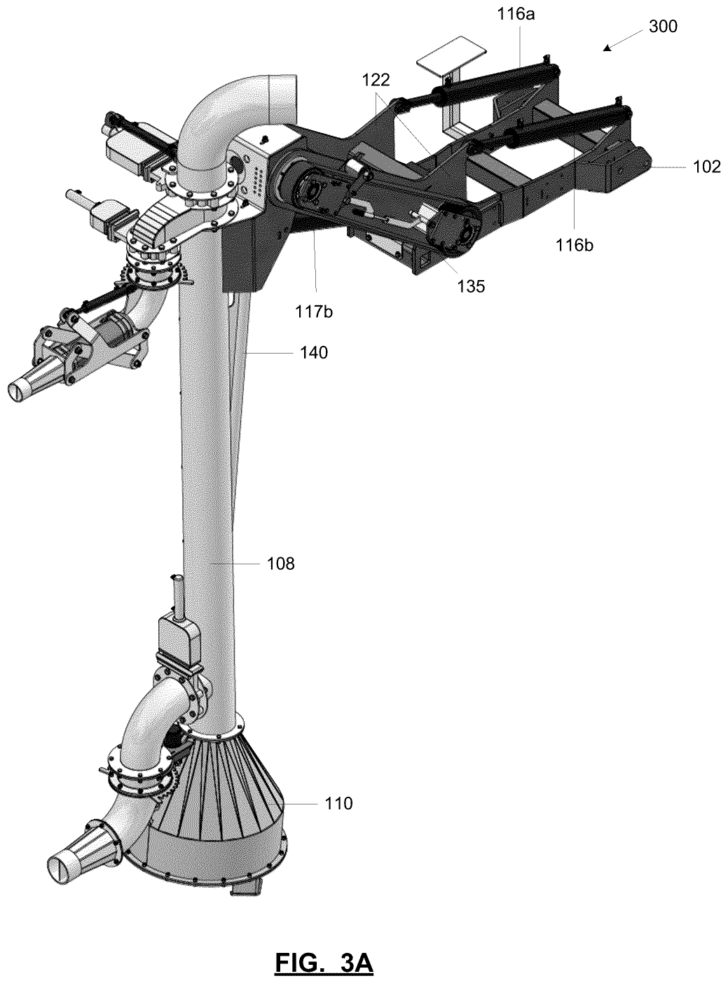

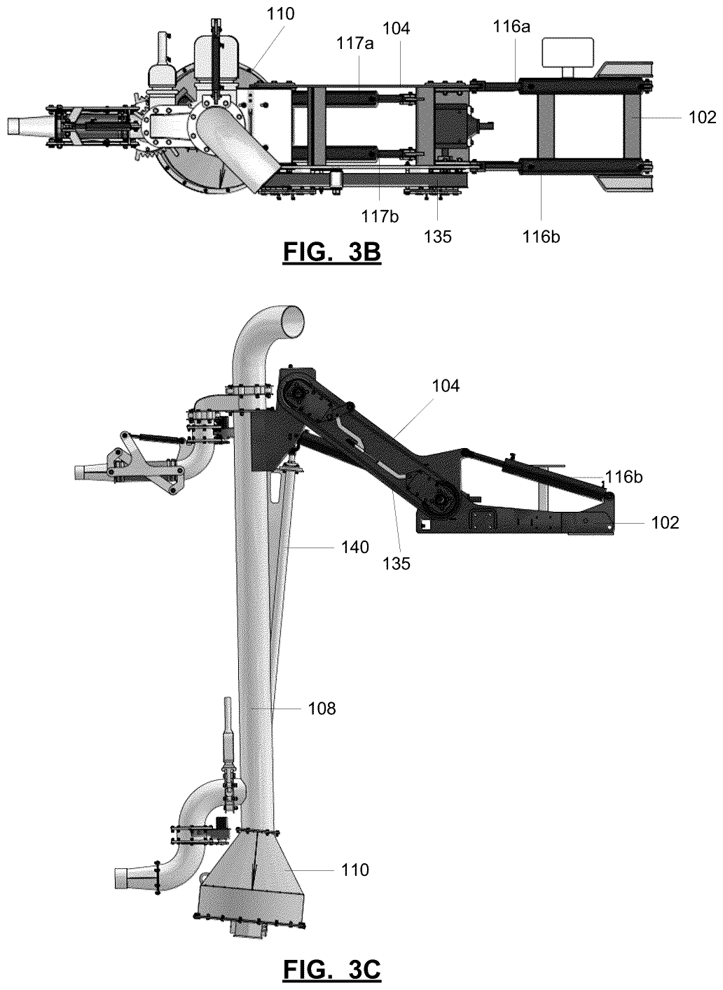

FIGS. 3A-3C show an articulating pump 300 according to at least one other embodiment described herein. The articulating pumps 100 and 300 differ in the mechanisms used to move their respective pump heads relative to their respective frames.

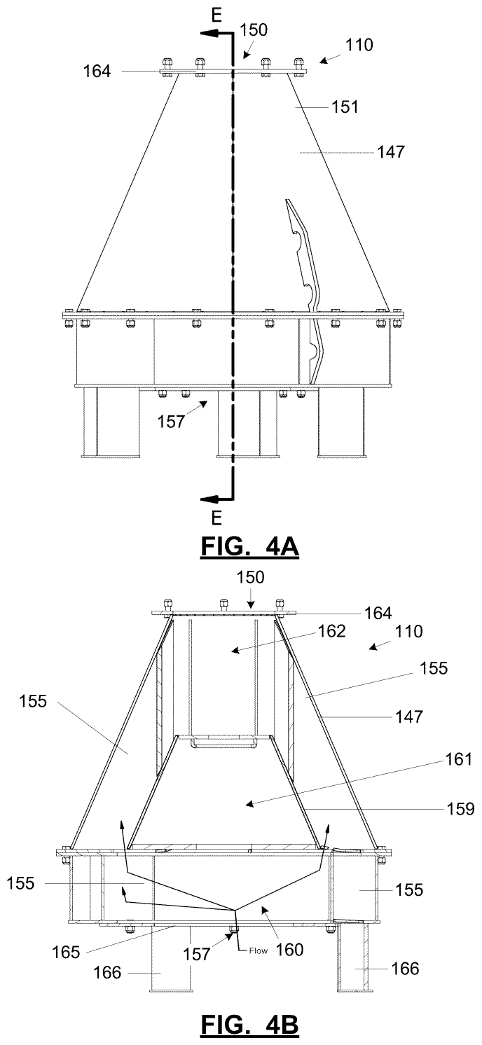

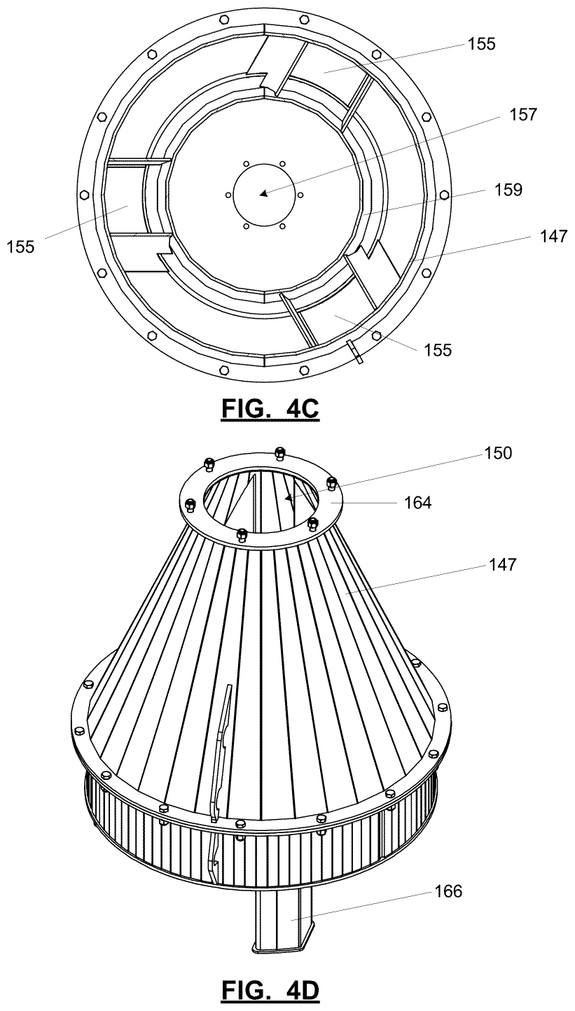

FIGS. 4A-4D show views of a pump head 110 according to at least one embodiment described herein. It should be understood that the pump head 110 may be included on any of the articulating pumps described herein. Alternate embodiments of pump heads are also described.

Each of the embodiments of articulating pumps described herein is configured to be attached to an implement that can act as a power source, such as but not limited to a tractor. The tractor may provide power to the articulating pump for both changing a position of a pump head thereof within a fluid reservoir and for activating an impeller of the pump head that removes fluid (e.g., manure) from the fluid reservoir via a fluid conduit of the pump.

Each of the embodiments of articulating pumps described herein is configured to move a pump head in at least two directions of a plane: a first direction extending vertically relative to the rear end of the implement (e.g., downwardly into and upwardly out of the fluid reservoir) and a second direction extending outwardly from the rear end of the implement. In some instances, the pumps may also provide for moving the pump head in a direction forward of the rear end of the implement (e.g., underneath the implement).

### FRAME AND GEARS

Referring now to the figures, FIGS. 1A-1H show an articulating pump 100 that includes a frame 102 configured to be coupled at a first end 102a thereof to an implement. A second end 102b of frame 102 is configured to be rotatably coupled to a pump body 103 having a first body portion 104. First body portion 104 is then rotatably coupled to a second body portion 106 (see FIG. 1B). Second body portion 106 is coupled to an elongated fluid conduit 108 that extends downwardly relative to frame 102. A pump head 110 is mounted to a bottom end 108b of the fluid conduit 108. When pump head 110 is submerged in a fluid, an impeller 112 of pump head 110 may be activated to direct fluid upwardly from the pump head 110 into the fluid conduit 108. Fluid conduit 108 has an inlet 113 coupled to pump head 110 and an outlet 114 at an upper end 108a thereof for discharging the fluid appropriately.

Articulating pump 100 includes two or more pairs of actuators, or other mechanisms, for controlling movement of the pump head 110 relative to frame 102. In the embodiment shown in FIGS. 1A-1H, frame 102 includes three pairs of actuators 116, 117, 118, respectively, to control movement of the pump head 110 relative to frame 102. FIGS. 3A-3C show an alternate embodiment of an articulating pump 300 including two pairs of actuators 116, 117 and is described in greater detail below.

Herein, the term actuator may refer to a hydraulic actuator, an electric actuator, or another means for transferring power. The three pairs of actuators 116, 117, 118, respectively, shown in pump 100 include two pairs of actuators 116, 118 that are positioned on an upper side of pump body 103 and a single pair of actuators 117 positioned on an underside of pump body 103.

The first pair of actuators 116 including a first actuator 116a and a second actuator 116b are shown at least in FIGS. 1A, 1B, 1E-1H. Each actuator 116a, 116b is coupled at a first end 115 thereof to a first end 102a of frame 102 and at a second end 119 thereof to a respective flange 122. Flange 122 is coupled (e.g., fixedly) to and extends upwardly from first end 104a of first body portion 104 (see FIG. 1B). First end 102a of frame 102 is configured to be coupled to the implement.

As each actuator 116 extends from an extended position to a retracted position, first body portion 104 rotates upwardly relative to frame 102. Conversely, as each actuator 116 extends from a retracted position to an extended position, first body portion 104 rotates downwardly relative to frame 102.

A second pair of actuators 118 including a first actuator 118a and a second actuator 118b are also shown at least in FIGS. 1A, 1B, 1E-1H. Each actuator 118a, 118b is coupled at a first end 121 thereof to a respective flange 122 and at a second end 125 to a second end 104b of first body portion 104. For example, second end 125 of each actuator 118a, 118b may be coupled to a portion of second end 104b of first body portion 104 that extends upwardly from first body portion 104. Also, respective flanges 122 may be coupled to each other by a crossing member 124.

As each actuator 118 extends from an extended position to a retracted position, first body portion 104 rotates upwardly relative to frame 102. Conversely, as each actuator 118 extends from a retracted position to an extended position, first body portion 104 rotates downwardly relative to frame 102. In at least one embodiment, first body portion 104 has a range of motion of at least 90 degrees, or at least 135 degrees, or at least 180 degrees, or between 180 and 270 degrees.

The first pair of actuators 116 may be operated independently from the second pair of actuators 118 or may be operated simultaneously with the second pair of actuators 118.

FIG. 1G is a side view of the articulating pump 100 of FIG. 1A at a fully retracted position and FIG. 1H is a side view of the articulating pump of FIG. 1A at a fully extended position. At the fully retracted position of FIG. 1G, each of the first pair of actuators 116 and the second pair of actuators 118 are retracted, resulting in the pump head 100 being raised above frame 102. At the fully extended position of FIG. 1H, each of the first pair of actuators 116 and the second pair of actuators 118 are extended, resulting in the pump head 100 being at a maximum depth (i.e., distance vertically from frame 102) below frame 102.

Articulating pump 100 shown in FIGS. 1A-1H also includes a third pair of actuators, or other mechanisms, 117 coupled to first end 104a of first body portion 104 and a first end 128 of second body portion 106. This can be seen in FIG. 1B. In this embodiment, as each actuator 117 extends from an extended position to a retracted position, second body portion 106 rotates rearwardly (e.g. towards the implement and/or frame 102). Conversely, as each actuator 116 extends from a retracted position to an extended position, second body portion 106 rotates in a frontward direction (e.g., away from the implement and/or frame 102). In at least one embodiment, second body portion 106 has a range of motion of at least 45 degrees, or at least 90 degrees, or at least 135 degrees, or at least 180 degrees, or between 90 and 180 degrees. Each actuator 117 may be coupled to a system of the implement to provide for moving between the extended and retracted positions.

In articulating pump 100, first body portion 104 rotates about a fixed pivot to rotate relative to frame 102 and second body portion 106 rotates about a fixed pivot to rotate relative to first body portion 104.

Articulating pump 100 also includes a gearbox 138 (see FIG. 1B) positioned where second body portion 106 rotates relative to first body portion 104. Gearbox 138 is connected to a drive shaft 140 that extends downwardly therefrom to pump head 110. In this embodiment, gearbox 138 may be powered by a standard power take-off (PTO) 127 from the implement. The connection between the PTO 127 and the fixed pivot between frame 102 and first body portion 104 at gearbox 137 is shown in FIG. 1B. FIGS. 1B and 1C also show how the drive shaft 140 inserts into pump head 110, which is described in greater detail below.

FIGS. 1A, 1E and 1F, at least, show showing a belt 135 that connects first body portion 104 and second body portion 106. Belt 135 is coupled to a first gear box 137 positioned where frame 102 meets first body portion 104 and a second gear box 138 where first body portion 104 meets second body portion 106. In this embodiment, a standard power take-off (PTO) shaft 127 from the implement can be connected to the first gear box 137 and the belt 135 can be coupled to first gear box 137 outwardly from the position where the PTO shaft 127 couples to the first gear box 137, which is positioned where the first end 104a of first body portion 104 is rotatably coupled to frame 102. Importantly, it should be noted that frame 102 remains level during operation of the articulating pump 100, so the PTO shaft 127 from the implement remains level and straight during operation (i.e., movement) of articulating pump 100.

FIG. 1B shows the positioning of the first gear box 137, the second gear box 138 and the actuators 116, 117, 118. Gear boxes 137 and 138 are positioned in a center of respective pivot points of pump 100, more specifically between frame 102 and first body portion 104 and between first pump body potion 104 and second body portion 106, respectively. By having the gear boxes 137 and 138 positioned in the center of pivot points of pump 100, pump 100 may be in any position (i.e., pump head 110 may be moved to any position, and first pump body potion 104 and second body portion 106 may be in any position) while belt 135 transfers power from the PTO 127 to gearbox 138 moves the drive shaft 140 can rotate the impeller 112 of the pump head 110 and pump 100 can operate and fluid from the fluid reservoir can be pumped.

Moving ahead, FIGS. 2A-2C show an embodiment of an articulating pump 200, where belt 135 is replaced with a shaft 139. Shaft 139 connects to a third gear box 143 and a fourth gear box 145 to transfer power from the PTO shaft 127 coupled to first gear box 137 to the drive shaft 140 (via second gear box 138).

Turning now to FIGS. 3A-3C, shown therein is another embodiment of an articulating pump 300. In this embodiment articulating pump 300 includes two pairs of actuators, or other mechanisms, for controlling movement of the pump head 110 relative to frame 102. In this embodiment, two pairs of actuators 116, 117 are shown.

The first pair of actuators 116 includes a first actuator 116a and a second actuator 116b each coupled at a first end 115 thereof to a first end 102a of frame 102 and at a second end 119 thereof to a respective flange 122. Flange 122 is coupled (e.g., fixedly) to and extends upwardly from first end 104a of first body portion 104. As each actuator 116 extends from an extended position to a retracted position, first body portion 104 rotates upwardly relative to frame 102. Conversely, as each actuator 116 extends from a retracted position to an extended position, first body portion 104 rotates downwardly relative to frame 102.

Each actuator 117a, 117b of the third pair of actuators 117 is coupled to first end 104a of first body portion 104 and a first end 128 of second body portion 106. This can be seen in FIG. 3C. In this embodiment, as each actuator 117 extends from an extended position to a retracted position, second body portion 106 again rotates rearwardly (e.g. towards the implement and/or frame 102). Conversely, as each actuator 116 extends from a retracted position to an extended position, second body portion 106 rotates in a frontward direction (e.g., away from the implement and/or frame 102). In at least one embodiment, second body portion 106 has a range of motion of at least 45 degrees, or at least 90 degrees, or at least 135 degrees, or at least 180 degrees, or between 90 and 180 degrees. Each actuator 117 may be coupled to a system of the implement to provide for moving between the extended and retracted positions.

Each of articulating pumps described herein can also include an agitation nozzle 144 coupled to elongated fluid conduit 108 near pump 100. Agitation nozzle 144 is coupled to the elongated fluid conduit 108 by, optionally a flexible tube. Agitator nozzle 144 can be used for directing a portion of the fluid passing through the elongated fluid conduit 108 outwardly from the elongated fluid conduit 108 and back towards the surface of the fluid reservoir. The fluid can be used to disrupt cake and thick material on the surface of the fluid within the fluid reservoir. A second agitation nozzle 146 can also be added to the top of fluid conduit 108. Second agitation nozzle 146 can also direct fluid up and down to assist with agitating fluid and the breaking up of cake on the surface of the fluid reservoir. Agitator nozzle 144 and agitator nozzle 146 function independently of each other. This allows the flow of agitation from each nozzle 144, 146 to oppose each other and assist in breaking up solids.

### PUMP HEAD

Returning to FIG. 1C, shown therein is a magnified portion B of FIG. 1B. Therein, drive shaft 140 is shown passing though housing 142 of elongated fluid conduit 108. Drive shaft 140 extends perpendicularly from gear box 138 and into opening 150 (see FIG. 4A) in pump head 110. Elongated fluid conduit 108 is therefore transverse to drive shaft 140 as both drive shaft 140 and elongated fluid conduit 108 pass through opening 150 of pump head 110. Drive shaft 140 therefore passes through a sidewall 141a of housing 141 of elongated fluid conduit 108 for the driveshaft 140 to enter the pump head 110 through opening 150 in a center of an upper portion 151 of the pump head 110.

Turning now to FIGS. 4A-4D, shown therein are various views of pump head 110. As noted above, pump head 110 includes an opening 150 in an upper portion 151. Upper portion 151 is connected to lower portion 152 by a series of fasteners. Upper portion 151 being removable form lower portion 152 by a series of fasteners provides for ease of maintenance of pump head 110, as internal components of the pump head 110 are accessible by disconnecting the upper portion 151 and the lower portion 152. Pump head 110 generally has a frustoconical shape with the opening 150 at a top end thereof.

Impeller 112 is a rotating component that accelerates fluid outwardly from the center of rotation and upwardly, thus transferring energy from the driveshaft that drives the impeller 112 to the fluid being pumped. Impeller 112 includes a series of blades that are configured to direct the fluid both tangentially and upwardly, relative to the plane of rotation of the impeller 112 when the fluid enters the outer housing 147 For example, the blades of impeller 112 may have a curved profile so rotation of the impeller 112 causes the fluid to follow the curvature of the blade and directs the fluid upwardly along the blades and into a first cavity 160 (see FIG. 4B) of the pump head 110. Once the fluid enters the first cavity 160, the fluid travels outward and upward relative to a center of the pump head 110 into the variable outlet cone positioned around and above impeller 112. Directions of movement of the fluid within pump head 110 are indicated by arrows in FIG. 4B. The existence of additional vanes within the variable outlet cone reduces the resistance experienced by the fluid as it exits the pump head 110, improving pump efficiency.

Fluid is directed by impeller 112 into vanes 155 passing through the pump head 110, as shown in FIGS. 4B and 4C. For example, in the embodiment shown in the drawings, the pump head 110 includes three vanes 155 that each direct the fluid upwardly from first cavity 160 fluidly connected to the inlet 157 towards the opening 151 and into the elongated fluid conduit 108. Inlet 157 of pump head 110 is positioned in a center of pump head 110 on an underside thereof. It should be noted that in FIG. 4C, inlet 157 may be enlarged so that roughly 50% of the center of the impeller is open.

Vanes 155 of the variable outlet cone carry fluid upwardly from first cavity 160 between an outer conical housing 147 and an inner conical housing 159. Each vane 155 carries fluid around a second cavity 161 defined by inner conical housing 159. The second cavity 161 houses a lower portion of drive shaft 140 (not shown) before the drive shaft 140 connects to impeller 112.

Each vane 155 meets at a third cavity 162 fluidly coupled to opening 150 that is the outlet for the fluid to exit the pump head 110 and enter elongated fluid conduit 108. Elongated fluid conduit 108 couples to the pump head 110 by a flange 164 extending around opening 150, however, any other suitable coupling method that provides for a sealed connection between the elongated fluid conduit 108 and the pump head 110 may be used.

Each vane 155 is shaped to provide for pressure differences at various places within the pump head 110 to build pressure therein. In this manner, the pump head 110 can be described as a single outlet, variable discharge pump head. The term “variable discharge” means that there is variable flow (e.g., different) rates at different positions between the outer and inner cones of pump head 110.

As noted above, the drive shaft 140 enters the opening 150 at an angle such that drive shaft 140 is perpendicular to opening 150. This makes drive shaft 140 in line with pump head 110. Contrary to this, elongated fluid conduit 108 is transverse to drive shaft 140 and therefore is slightly askew to pump head 110.

In at least one embodiment, the frustoconical shape of pump head 110 having a single outlet provides for the pump head to remain compact in size. This, combined with a drive shaft 140 that angles through sidewall 141a of housing 141 of elongated fluid conduit 108 and into the center of the pump head 110, keep the pump head 110 as small as possible. This provides for the pump head to access fluid reservoirs that have small access holes.

Pump head 110 may also include one or more feet 166 extending downwardly from lower surface 165 of pump head 110. Feet 166 may provide for lower surface 165 to be raised relative to a bottom surface of a fluid reservoir, thereby ensuring that the inlet 157 does not abut the bottom surface of a fluid reservoir and can receive fluid therein, While the above description provides examples of one or more apparatus, methods, or systems, it will be appreciated that other apparatus, methods, or systems may be within the scope of the claims as interpreted by one of skill in the art.

What is claimed is:

1. An articulating pump for submerging in a fluid reservoir, the articulating pump comprising:
a frame for coupling the pump to an implement;
a pump body rotatably coupled to the frame, the pump body having:
a first body portion rotatably coupled to the frame; and
a second body portion rotatably coupled to the first body portion;
an elongated fluid conduit coupled to the second body portion and extending downwardly relative to the frame;
a pump head coupled to an inlet of the elongated fluid conduit at a position spaced apart from the second body portion, the pump head having a fluid inlet on an underside and a fluid outlet on an upper side thereof, the elongated fluid conduit being fluidly coupled to the outlet to receive fluid from the pump head;
a drive shaft coupled to the second body portion of the pump body and extending downwardly relative to the frame, the drive shaft entering the pump head through the fluid outlet of the pump head and into a cavity of the pump head; and
an impeller coupled to the drive shaft, the impeller extending downwardly from the pump head to direct fluid from the fluid reservoir into the inlet of the pump head and, subsequently, the inlet of the elongated fluid conduit.

2. The pump of claim 1 further comprising at least one actuator coupled to the first body portion and the second body portion, the at least one actuator configured to rotate the second body portion about the first body portion.

3. The pump of claim 2 wherein the at least one actuator coupled to the first body portion and the second body portion includes a first pair of hydraulic actuators.

4. The pump of claim 1 further comprising at least one actuator coupled to the frame and to the first body, the at least one actuator configured to rotate the first body portion about the frame.

5. The pump of claim 4 wherein the at least one actuator coupled to the first body portion and the frame includes a second pair of hydraulic actuators.

6. The pump of claim 5 further comprising at least one actuator coupled to the first body portion and the second body portion.

7. The pump of claim 6, wherein the at least one actuator coupled to the first body portion and the second body portion includes a third pair of hydraulic actuators.

8. The pump of claim 1, wherein the drive shaft is transverse with the elongated fluid conduit.

9. The pump of claim 1, wherein the drive shaft is powered by a power source.

10. An articulating pump for submerging in a fluid reservoir, the articulating pump comprising:
a frame for coupling the pump to an implement;
a pump body rotatably coupled to the frame, the pump body having:
a first body portion rotatably coupled to the frame; and
a second body portion rotatably coupled to the first body portion;
a drive shaft coupled to the second body portion of the pump body and extending downwardly relative to the frame;
a drive means coupled to a power take-off of the implement and configured to transfer power of the implement to the drive shaft;
an elongated fluid conduit coupled to the second body portion and extending downwardly relative to the frame;
a pump head coupled to an inlet of the elongated fluid conduit at a positioned spaced apart from the second body portion, the pump head having a fluid inlet on an underside and a fluid outlet on an upper side thereof, the elongated fluid conduit being fluidly coupled to the outlet to receive fluid from the pump head;
an impeller coupled to the drive shaft, the impeller extending downwardly from the pump head to direct fluid from the fluid reservoir into the inlet of the pump head and, subsequently, the inlet of the elongated fluid conduit.

11. The pump of claim 10, wherein the drive means includes a first gear box, a second gear box, and a transfer mechanism to transfer power from the first gear box to the second gear box.

12. The pump of claim 11, wherein the transfer mechanism is a belt.

13. The pump of claim 11, wherein the transfer mechanism is a rotating shaft between two additional gear boxes

14. The pump of claim 11, wherein the first gear box is coupled to the first body portion.

15. The pump of claim 11, wherein the second gear box is coupled to the second body portion.

16. The pump of claim 11 further configured for the power to be transferred to the pump head while the first body portion and the second body portion are in any position.

17. A pump head of an articulating pump, the pump head comprising:
an outer conical outer housing having:
a fluid inlet on an underside of the outer housing;
a fluid outlet on an upper side of the outer housing, the fluid outlet being configured to be fluidly coupled to an inlet of an elongated conduit to direct fluid into the elongated fluid conduit; and
an inner cavity fluidly coupled to the fluid inlet;
an inner conical housing positioned within the outer conical housing, the inner housing defining a first inner cavity for receiving a drive shaft of the articulating pump, the drive shaft being coupled to an impeller extending outwardly from the fluid inlet on the underside of the inner cone; and
one or more vanes fluidly coupled to the inner cavity and configured to receive the fluid from the inner cavity and direct the fluid towards the fluid outlet, the vanes passing between the outer housing and the inner housing and around the inner housing.

18. The pump head of claim 17, wherein the outer housing has a frustoconical shape.

19. The pump head of claim 17, wherein the vanes are configured to carry the fluid in a first direction upwardly relative to the underside of the housing and a second direction curved around at least a portion of the inner housing.

20. The pump of claim 1 further comprising a pair of agitation nozzles, each agitation nozzle being configured to operate independently of the other agitational nozzle.
